(19) United States
(12) Patent Application Publication
(10) Pub. No.: US 2025/0038448 A1
(43) Pub. Date: Jan. 30, 2025

(54) FPC CONNECTOR AND CONNECTOR PAIR

(71) Applicant: Molex, LLC, Lisle, IL (US)

(72) Inventors: Tetsunori Tsumuraya, Yamato (JP); Hisashi Miyamoto, Yamato (JP)

(21) Appl. No.: 18/715,121

(22) PCT Filed: Dec. 13, 2022
(86) PCT No.: PCT/IB2022/062102

§ 371 Date: May 31, 2024

(30) Foreign Application Priority Data
Jan. 27, 2022 (JP) 2022-011065

(51) Int. Cl. H01R 13/50; H01R 12/77

(52) U.S. Cl. CPC H01R 13/50; H01R 12/778

(57) ABSTRACT

An FPC connector that includes: a housing enabling attaching of a FPC with a bifurcated tip, wherein the housing includes: a column section that engages a separation section formed in the center of the FPC in the width direction, and engagement protrusions that enter into and engage with engaging openings formed at both ends of the FPC in the width direction; the engagement protrusions are formed protruding from the side of the FPC opposite the reinforcement plate toward the reinforcement plate side; and the housing further includes a recessed section formed in the center thereof in the width direction and a slit formed in the recessed section that an internal end part of the FPC separation section fits into.

### RELATED APPLICATIONS

This application claims priority to Japanese Patent application no. 2022-011065, filed Jan. 27, 2022 which is incorporated herein by reference in their entirety.

### TECHNICAL FIELD

The present disclosure relates to a FPC connector and connector pair.

### BACKGROUND ART

Conventionally, connectors for flexible flat cables have been used to connect flexible flat cables called flexible circuit boards (FPC), flexible flat cables (FFC), and the like. This manner of connector is attached on the tip end of the flexible flat cable, and by mating with a counterpart connector, conduction of the flexible flat cable with the counterpart connector is enabled (for example, see Patent Document 1).

FIG. 27 is a perspective view illustrating a connector for a conventional flexible flat cable.

In the figure, 811 is a connector housing of the connector for the flexible flat cable for mating with a counterpart connector (not shown). The housing 811 includes a substantially square flat plate part 812, a pair of guide walls 813 formed on both the left and right sides of the flat plate part 812, a cable front end pressing piece 817 formed on the front end edge of the flat plate part 812, a cable guide piece 818 protruding from the inner surface near the rear end of each guide wall 813, and a cable engaging protrusion 819 formed on the upper surface of the flat plate part 812.

In addition, 890 is a flexible flat cable. The flexible flat cable 890 includes a plurality of conductors 892 that are mutually parallel and extend in the longitudinal direction thereof but an insulative covering that covers the upper surface of the conductors 892 is removed at a front end proximity section 891 of the flexible flat cable 890, exposing the conductors 892. Note that an engaging hole 893 is formed toward the back of the front end proximity section 891.

Furthermore, by moving the flexible flat cable 890 relative to the housing 811 from the back to the front thereof, as indicated by the arrow in the figure, the flexible flat cable 890 is attached to the connector. Herein, both left and right side edges of the flexible flat cable 890 pass through a space between the cable guide piece 818 and flat plate part 812, the front end of the flexible flat cable 890 enters into a space between the cable front end pressing piece 817 and the flat plate part 812 and the engaging hole 893 engages with the cable engaging protrusion 819. Thus, the flexible flat cable 890 is reliably attached to the housing 811 of the connector.

Prior Art Documents: Patent Documents: Patent Document 1: Japanese Unexamined Patent Application 2002-100425

### SUMMARY

However, with the conventional connector, simple, reliable attaching in a short period of time without mistaking front and back and without causing damage to a thin flexible flat cable 890 that easily deforms was difficult.

In particular, in recent years, connectors have become smaller and lower in profile and various sections have become miniaturized, making it difficult to visibly confirm that the front and back of the flexible flat cable 890 were not mistaken and attaching was performed correctly.

Here, an object is to provide a highly reliable FPC connector and connector pair that resolve the problems of conventional connectors, where even if small and low profile, exhibit high strength and enable simple, reliable, and precise mounting in a short period of time such that even a flexible circuit board (FPC) with a bifurcated tip will not be damaged and front and back will not be incorrect.

To achieve this, an FPC connector includes:
a housing enabling attaching of a FPC with a bifurcated tip, wherein
the housing includes: a column section that engages a separation section formed in the center of the FPC in the width direction, and engagement protrusions that enter into and engage with engaging openings are formed at both ends of the FPC in the width direction;
the engagement protrusions are formed protruding from the side of the FPC opposite the reinforcement plate toward the reinforcement plate side; and
the housing further includes a recessed section formed in the center thereof in the width direction and a slit formed in the recessed section that an internal end part of the FPC separation section fits into.

With another FPC connector, additionally, at least a portion of the column section deviates to one side or the other of the center of the recessed section in the width direction.

With yet another FPC connector, additionally, a viewing window enabling viewing the engagement state of the engaging opening and the engagement protrusion is formed in the outer wall surface of the housing.

With yet another FPC connector, additionally, the housing includes a press protrusion section formed to the outside of the engagement protrusion in the width direction that protrudes in the direction opposite the engagement protrusion and contacts a portion on the reinforcement plate side surface of the FPC that is closer to the front end than the engaging opening.

With yet another FPC connector, additionally, the housing includes a releasing space formed closer to the front than the engagement protrusion.

A connector pair includes a FPC connector according to the present disclosure and a counterpart connector that mates with the FPC connector.

With the present disclosure, despite being small and having a low profile, reliability of the FPC connector will be improved and will exhibit high strength, and will enable simple, reliable, and precise mounting in a short period of time such that even a FPC with a bifurcated tip will not be damaged and front and back will not be incorrect.

### BRIEF DESCRIPTION OF THE DRAWINGS

FIG. 1 is a first perspective view of the first connector according to Embodiment 1.

FIG. 2 is a second perspective view of the first connector according to Embodiment 1.

FIG. 3 is a two-plane view of the first connector according to Embodiment 1, where FIG. 3A is a top view and FIG. 3B is a sectional view taken along the line A-A in FIG. 3A.

FIG. 4 is a rear surface view of the first connector according to Embodiment 1.

FIG. 5 is a cross-sectional view of the first connector according to Embodiment 1, where FIG. 5A is a sectional view taken along the line B-B in FIG. 4 and FIG. 5B is a sectional view taken along the line C-C in FIG. 4.

FIG. 6 is a front view of the first connector according to Embodiment 1, where FIG. 6A is an overall view and FIG. 6B is an exploded view of the D part of FIG. 6A.

FIG. 7 is an oblique front view of the first connector according to Embodiment 1, where FIG. 7A is an overall view and FIG. 7B is an exploded view of the E part of FIG. 7A.

FIG. 8 is a plan view of near the tip end of the FPC according to Embodiment 1, where FIG. 8A is a plan view of the upper side FPC and FIG. 8B is a plan view of the lower side FPC.

FIG. 9 is a two-plane view of the first connector mounted on a FPC according to Embodiment 1, where FIG. 9A is a top view and FIG. 9B is a sectional view taken along the line F-F.

FIG. 10 is a rear view of the first connector mounted on a FPC according to Embodiment 1.

FIG. 11 is a cross-sectional view of the first connector mounted to a FPC according to Embodiment 1, where FIG. 11A is a sectional view taken along the line G-G in FIG. 10 and FIG. 11B is a sectional view taken along the line H-H in FIG. 10.

FIG. 12 is a perspective view of the second connector according to Embodiment 1, where FIG. 12A is a first perspective view and FIG. 12B is a second perspective view.

FIG. 13 is a two-plane view of the second connector according to Embodiment 1, where FIG. 13A is a front view and FIG. 13B is a top view.

FIG. 14 is a top view illustrating the first connector and the second connector according to Embodiment 1 in a prior to mating state.

FIG. 15 is a top view illustrating the first connector and the second connector according to Embodiment 1 in a state of starting to mate.

FIG. 16 is a two-plane view illustrating the first connector and the second connector according to Embodiment 1 in a state of starting to mate, where FIG. 16A is a view from behind the first connector and FIG. 16B is a sectional view taken along the line I-I in FIG. 16A.

FIG. 17 is a first two-plane view illustrating the first connector and the second connector according to Embodiment 1 in a state in the middle of mating, where FIG. 17A is a top view and FIG. 17B is a sectional view taken along the line J-J in FIG. 17A.

FIG. 18 is a second two-plane view illustrating the first connector and the second connector according to Embodiment 1 in a state in the middle of mating, where FIG. 18A is a view from behind the first connector and FIG. 18B is a sectional view taken along the line K-K in FIG. 18A.

FIG. 19 is a first two-plane view illustrating the first connector and the second connector according to Embodiment 1 in a state at the end of mating, where FIG. 19A is a top view and FIG. 19B is a sectional view taken along the line L-L in FIG. 19A.

FIG. 20 is a second two-plane view illustrating the first connector and the second connector according to Embodiment 1 in a state at the end of mating, where FIG. 20A is a view from behind the first connector and FIG. 20B is a sectional view taken along the line M-M in FIG. 20A.

FIG. 21 is a perspective view of the first connector according to Embodiment 2, where FIG. 21A is a view seen obliquely from the front and FIG. 21B is a view seen obliquely from the rear.

FIG. 22 is a first two-plane view of the first connector according to Embodiment 2, where FIG. 22A is a rear view and FIG. 22B is a bottom view.

FIG. 23 is a second two-plane view of the first connector according to Embodiment 2, where FIG. 23A is a top view and FIG. 23B is a sectional view taken along the line N-N in FIG. 23A.

FIG. 24 is a three-plane diagram of the first connector mounted on a FPC according to Embodiment 2, where FIG. 24A is a top view, FIG. 24B is a rear view, and FIG. 24C is a sectional view taken along the line O-O in FIG. 24A.

FIG. 25 is a perspective view of the second connector of Embodiment 2, where FIG. 25A is a view seen obliquely from the front and FIG. 25B is a view seen obliquely from the rear.

FIG. 26 is a two-plane view illustrating the second connector according to Embodiment 2, where FIG. 26A is a top view and FIG. 26B is a front view.

FIG. 27 is a perspective view illustrating a connector for a conventional flexible flat cable.

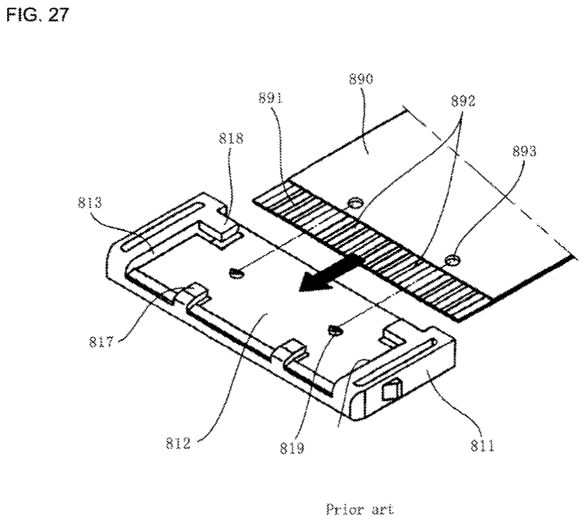

### DETAILED DESCRIPTION OF THE PREFERRED EMBODIMENTS

Embodiments will hereinafter be described in detail with reference to the drawings.

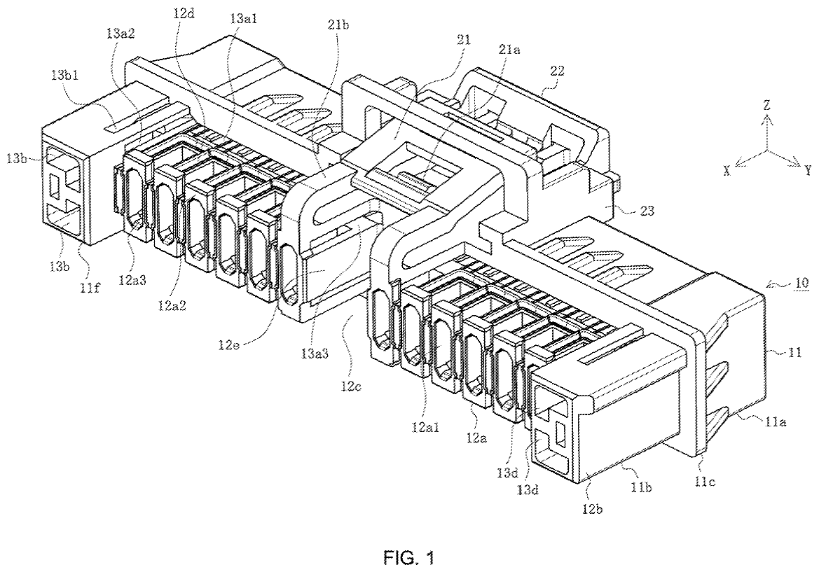

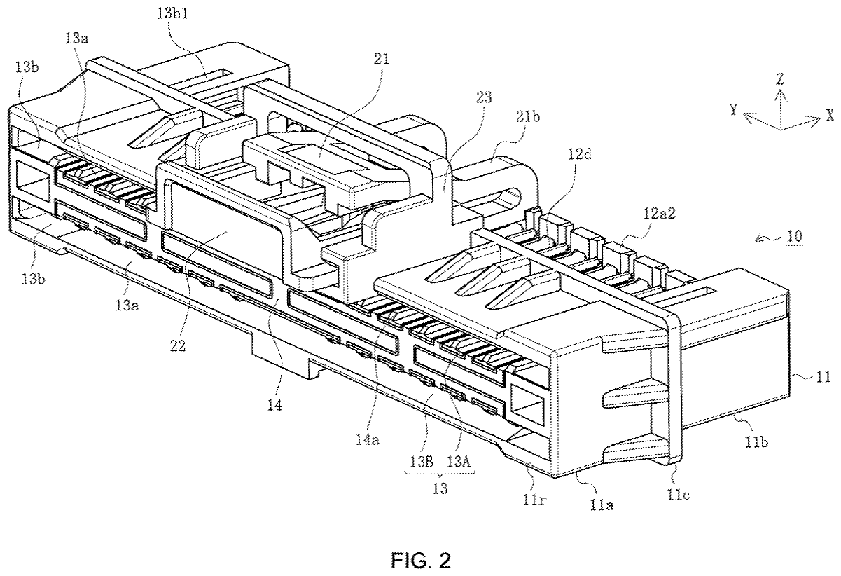

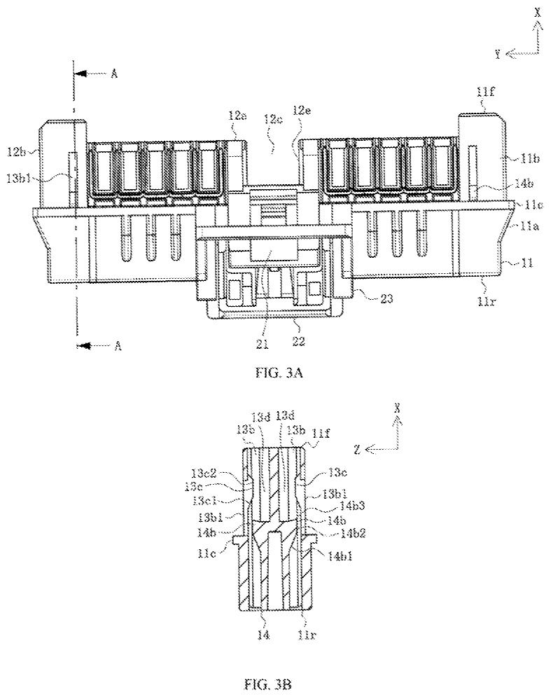

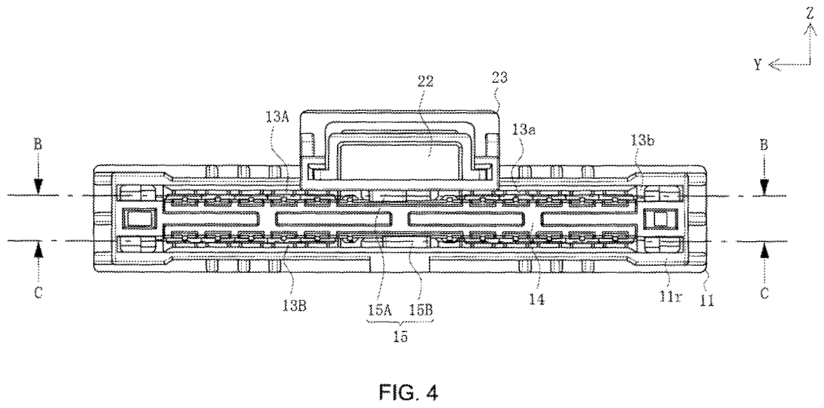

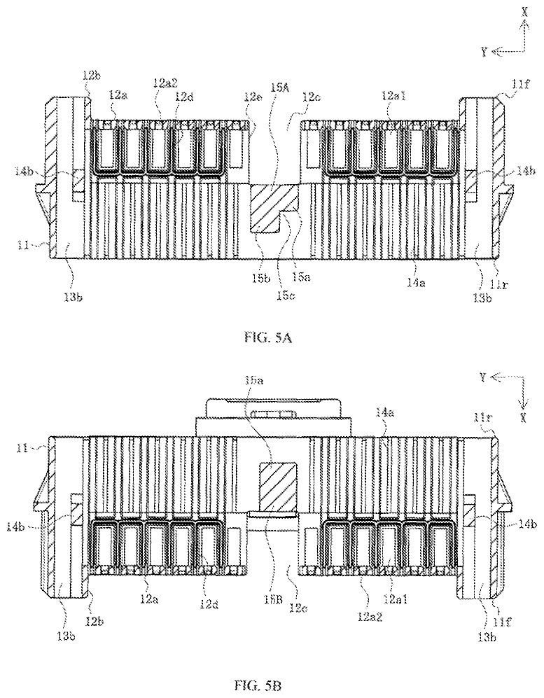

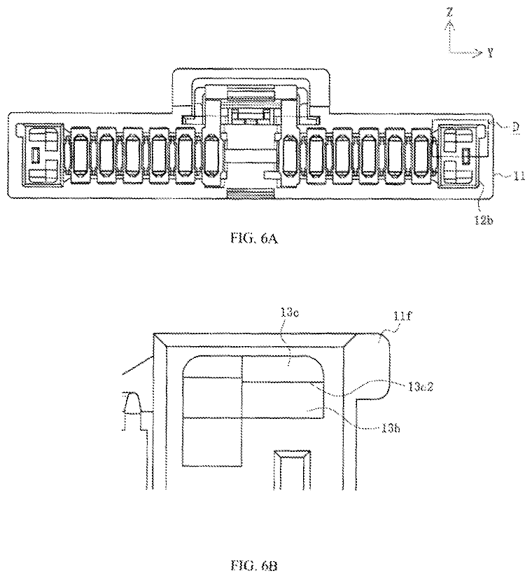

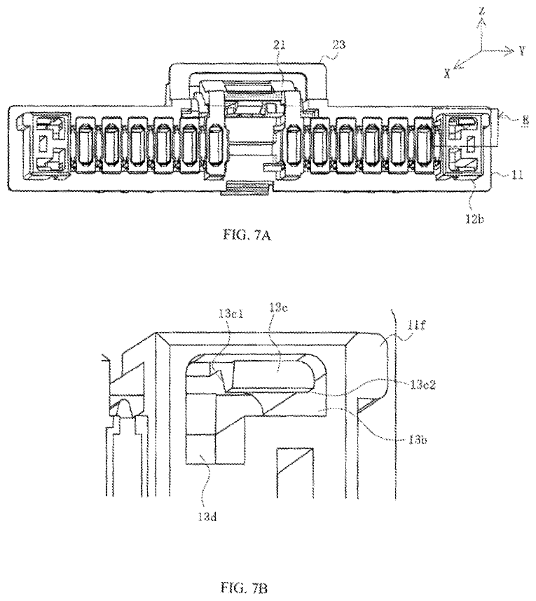

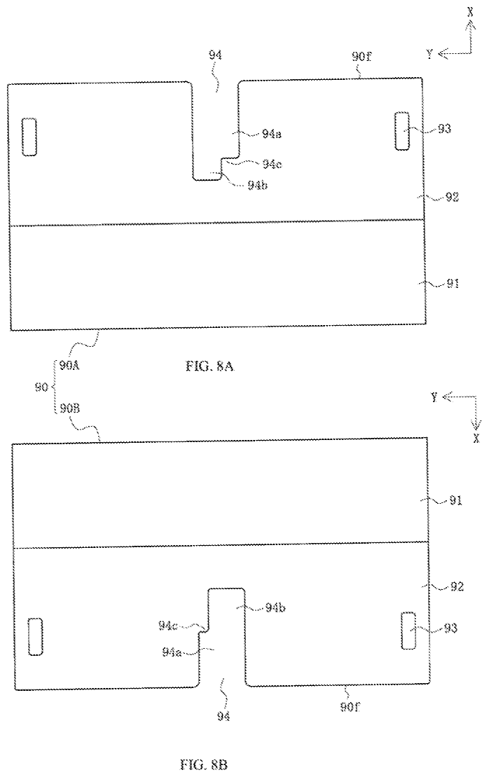

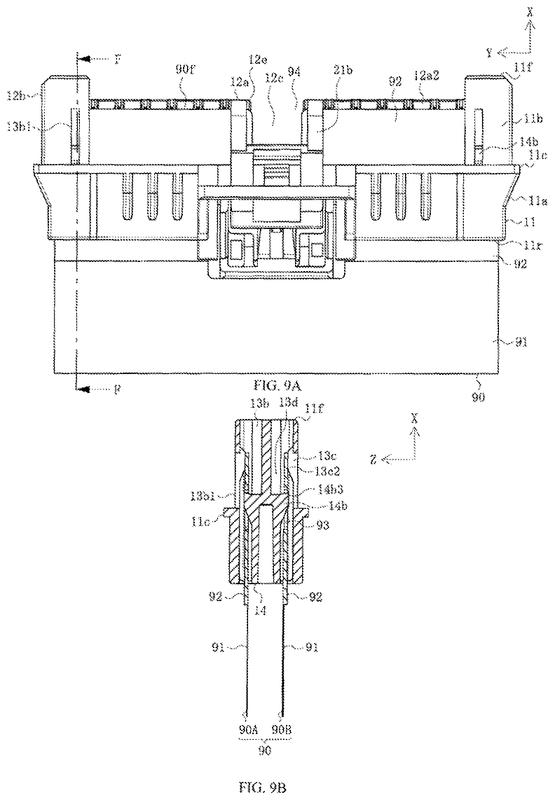

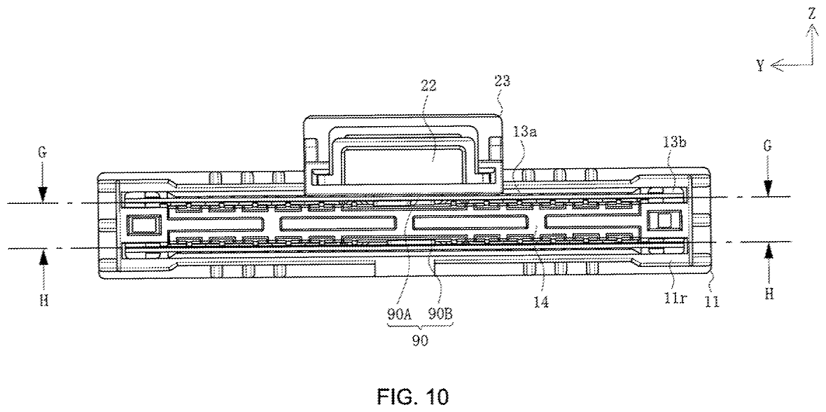

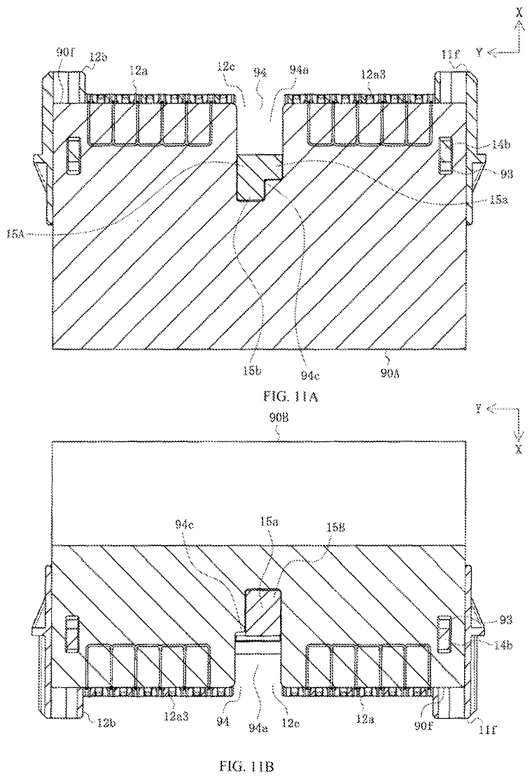

FIG. 1 is a first perspective view of the first connector according to Embodiment 1. FIG. 2 is a second perspective view of the first connector according to Embodiment 1. FIG. 3 is a two-plane view of the first connector according to Embodiment 1. FIG. 4 is a rear view of the first connector according to Embodiment 1. FIG. 5 is a cross-sectional view of the first connector according to Embodiment 1. FIG. 6 is a front view of the first connector according to Embodiment 1. FIG. 7 is a front view of the first connector according to Embodiment 1 seen obliquely. FIG. 8 is a plan view near the tip end of the FPC according to Embodiment 1. FIG. 9 is a two-plane view of the first connector mounted on a FPC according to Embodiment 1. FIG. 10 is a rear view of the first connector mounted on a FPC according to Embodiment 1. FIG. 11 is a cross-sectional view of the first connector mounted to a FPC according to Embodiment 1. Note that in FIG. 3, (a) is top view and (b) is a sectional view taken along the line A-A in (a). In FIG. 5, (a) is a sectional view taken along the line B-B in FIG. 4 and (b) is a sectional view taken along the line C-C in FIG. 4. In FIG. 6, (a) is an overall view and (b) is an exploded view of the D part of (a). In FIG. 7, (a) is an overall view and (b) is an exploded view of the E part of (a). In FIG. 8, (a) is a plan view of the upper side FPC and (b) is a plan view of the lower side FPC. In FIG. 9, (a) is a top view and (b) is a sectional view taken along the line F-F in (a). In FIG. 11, (a) is a sectional view taken along the line G-G in FIG. 10 and (b) is a sectional view taken along the line H-H in FIG. 10.

In the figures, 10 is a first connector according to the present Embodiment, being one connector included in a connector pair that mates with a second connector 101, described below, as a counterpart connector. With the present Embodiment, the first connector 10 is a FPC connector mounted to a FPC 90 and used as a so-called jacket for electrically connecting the FPC 90, which is a flexible circuit board, to the second connector 101. Note that with the present Embodiment, FPC means not only flexible circuit boards but also flexible flat boards to flexible flat cables including a flexible flat cable called a FFC and may be any type of flexible flat board to flexible flat cable.

In Embodiment 1, expressions indicating directions such as top, bottom, left, right, front, rear, and the like used to describe a configuration and operation of each unit of the first connector 10, the second connector 101, the FPC 90, and the like are relative rather than absolute, and are proper when each unit of the first connector 10, the second connector 101, the FPC 90, and the like are in positions illustrated in the drawings, but should be changed and interpreted according to a change in position when the posture changes.

Furthermore, the first connector 10 has a first housing 11 as a housing integrally formed of an insulating material such as synthetic resin. As illustrated in the figure, the first housing 11 has a substantially rectangular body external shape elongated in the width direction (Y axis direction). Furthermore, the first housing 11 includes a main body section 11a, being the side the FPC 90 is inserted into, or in other words, a rear side (X axis negative direction side), and a mating section 11b connected on the front surface (X axis positive direction side surface) of the main body section 11a that mates with the second connector 101. In addition, a flat plate shaped flange section 11c is formed extending in the width direction (Y axis direction) between the main body section 11a and a mating section 11b. Note that the rear end surface of the main body section 11a is called the rear surface 11r of the first housing 11 and the front end surface of the mating section 11b is called the front surface 11f of the first housing 11.

The mating section 11b includes mating side sections 12b positioned on both ends thereof in the width direction (Y axis direction), having a polygonal column type shape, and extending forward (X axis positive direction) from the flange section 11c, and a mating main section 12a demarcated on the left and right ends by the mating side sections 12b. Note that the front end surfaces of the mating side sections 12b function as the front surface 11f while the front end surface of the mating main section 12a is positioned back (X axis negative direction) from the front surface 11f. In addition, the mating main section 12a is provided with a plurality of terminal insertion recessed sections 12a1 that at least the contact protrusions 165a of the terminals 161 (described below) provided in the second connector 101 are inserted into when the first connector 10 and the second connector 101 are mated together, and which are formed lined up in the width direction. The number and pitch of the terminal insertion recessed sections 12a1 are set to correspond to the number and pitch of the terminals 161. Note that each of the terminal insertion recessed sections 12a1 are formed with an opening on the front end surface of the mating main section 12a and also formed with an opening on mating main planes 12d above and below the mating main section 12a.

The front end of the mating main planes 12d are demarcated by front end protrusion sections 12a2 that protrude up and down at the front end surface of the mating main section 12a. In addition, a tip end guide 12a3 that a front end 90f of the FPC 90 abuts or is adjacent to is formed in the opening of the terminal insertion recessed section 12a1 of the front end protrusion sections 12a2. The protrusion height of this tip end guide 12a3 is set so as to be lower than the surface of the conductor wire exposed on the surface side of the FPC 90.

Furthermore, a mating recessed section 12c is formed as a recessed section where the mating section 11b is missing in the middle of the mating main section 12a in the width direction (Y axis direction). As viewed from a vertical direction (Z axis direction), the mating recessed section 12c is a substantially rectangular space, indented from the front end surface of the mating main section 12a to the flange section 11c, and the left and right sides thereof are demarcated by mating internal wall sections 12e extending in the front-to-back direction as well as the up-and-down direction.

In addition, as a mated state retaining device for retaining a mated state with the second connector 101, a lock member 21 is formed in the middle in the width direction (Y axis direction) of the upper surface (Z axis positive direction surface) of the first housing 11. This lock member 21 includes a pair of locking arm sections 21b on the left and right and a lock protruding section 21a having both ends thereof connected to the middle sections of the locking arm sections 21b. Each of the locking arm sections 21b are elastically deformable cantilever type members with the base end thereof connected to the upper surface of the mating internal wall sections 12e that demarcate both sides of the mating recessed section 12c in the width direction and extend in a straight line in the rear direction (X axis negative direction), when viewed from a vertical direction (Z axis direction). In addition, a lock retaining section 23 is formed on the upper surface of the main body section 11a to the rear of the lock member 21 and a secondary lock member 22 is attached to the lock retaining section 23 so as to enable sliding forward as a contact position assurance mechanism (CPA). This secondary lock member 22 functions in the same manner as a general CPA where upon completion of mating the first connector 10 and the second connector 101 and locking the second connector 101 with the lock member 21, is a member that when slid forward, prevents operation in the direction of the lock member 21 that would release the mated state.

Furthermore, a board insertion recessed section 13 is formed in the first housing 11 as a FPC insertion recessed section that at least the section near the front end 90f of the FPC 90 is inserted into. The board insertion recessed section 13 extends in the front-to-back direction (X axis direction), is a recessed section that opens in a narrow long slit manner extending in the width direction (Y axis direction) at the rear surface 11r of the first housing 11, and is demarcated into an upper side board insertion recessed section 13A and a lower side board insertion recessed section 13B by a partition wall 14 that extends in the width direction. In other words, the first housing 11 includes two board insertion recessed sections 13. Furthermore, an upper side FPC 90A of the FPC 90 is inserted into an upper side board insertion recessed section 13A and a lower side FPC 90B of the FPC 90 is inserted into a lower side board insertion recessed section 13B.

Note that in the present Embodiment, board insertion recessed section 13 will be used as a collective description of the upper side board insertion recessed section 13A and lower side board insertion recessed section 13B. Also, FPC 90 will be used as a collective description of the upper side FPC 90A and lower side FPC 90B.

Each of the board insertion recessed sections 13 include an end part insertion recess section 13b positioned at both ends in the width direction (Y axis direction) and a center insertion recessed section 13a connected on the left and right ends to the end part insertion recess sections 13b.

In the mating section 11b, the end part insertion recess sections 13b extend in the front-to-back direction within the mating side sections 12b and are open on the front end surface of the mating side sections 12b. Furthermore, a window 13b1 is formed in a slit shape extending in the front-to-back direction in the outer wall surface of the first housing 11, specifically, in the upper surface (Z axis positive direction surface) and bottom surface (Z axis negative direction surface) of the mating side sections 12b as a viewing window for the end part insertion recess sections 13b. Thus, the end part insertion recess sections 13b in the mating side section 12b are connected vertically to the outside of the first housing 11 through the window 13b1 so the end part insertion recess sections 13b can be viewed through the window 13b1.

In addition, the center insertion recessed section 13a communicates with the space above the surface of the mating main planes 12d above and below the mating main section 12a through a front-to-back communication opening 13a1 formed on the flange section 11c as a communication opening. In other words, the front end 90f of the portion of the FPC 90 inserted into the center insertion recessed section 13a is able to pass through the front-to-back communication opening 13a1, slide along the surface of the mating main planes 12d, and reach the front end protrusion section 12a2 that demarcates the front end of the mating main planes 12d.

Furthermore, the end part insertion recess section 13b inside the mating side section 12b communicates with the space above the surface of the mating main planes 12d above and below the mating main section 12a through a side section communication opening 13a2 formed on the side surface in the mating side section 12b as a communication opening. Furthermore, the mating recessed section 12c communicates with the space above the surface of the mating main planes 12d above and below the mating main section 12a through a recessed communication opening 13a3 formed in the mating internal wall section 12e as a communication opening, being a slit. In other words, the portion of the FPC 90 inserted along the surface of the mating main planes 12d can be maintained in a state of connection with the portion inserted into the end part insertion recess section 13b in the mating side section 12b and a portion thereof can be exposed to the inside of the mating recessed section 12c.

A plurality of long and narrow ribs 14a protrude extending from the upper and lower surfaces within the center insertion recessed section 13a on the partition wall 14 in the front-to-back direction. Since the surface of the FPC 90 that is inserted in the board insertion recessed section 13 on the partition wall 14 side slides along the surface of the long and narrow ribs 14a, sliding resistance can be reduced enabling smooth sliding.

In addition, as illustrated in FIGS. 3 and 5, engaging protrusions 14b are formed protruding on the upper and lower surfaces on the partition wall 14 inside the end part insertion recess sections 13b. The engaging protrusions 14b enter into and engage with engaging openings 93 formed on both ends in the width direction of the FPC 90. Thus, inadvertent pulling out of the FPC 90 inserted into the board insertion recessed section 13 is prevented. Note that as illustrated in FIG. 3(b), each of the engaging protrusions 14b include a top surface section 14b2 that extends in the front-to-back direction, an inclined surface section 14b1 connected to the rear end (X axis negative direction end) of the top surface section 14b2, and an engaging surface section 14b3 connected to the front end (X axis positive direction end) of the top surface section 14b2 that extends in the vertical direction (Z axis direction).

Furthermore, releasing spaces 13d closer to the front surface 11f than the engaging protrusions 14b are formed in the end part insertion recess sections 13b. The releasing spaces 13d are spaces enabling insertion of a releasing tool (not shown) when disengaging the FPC 90 attached to the first connector 10 and releasing engagement of the engaging protrusions 14b in the engaging openings 93.

In addition, press protrusion sections 13c are formed in the end part insertion recess sections 13b in the mating side sections 12b on the surface opposite the partition wall 14 and protruding in the opposite direction of the engaging protrusions 14b, in other words, protruding towards the partition wall 14. The press protrusion sections 13c are formed more forward than the engaging protrusions 14b and more to the outside in the width direction. When the FPC 90 is inserted into the board insertion recessed sections 13, the engaging protrusions 14b enter into and engage with the engaging openings 93 formed at both ends in the width direction and portions closer to the front end 90f of the FPC 90 and closer to the ends in the width direction than the engaging openings 93 are pressed towards the partition wall 14 by the press protrusion sections 13c, so the engaging protrusions 14b are reliably prevented from separating from the engaging openings 93. Note that as illustrated in FIG. 3(b), each press protrusion section 13c includes a top surface section 13c2 that extends in the front-to-back direction and an inclined surface section 13c1 connected to the rear end (X axis negative direction end) of this top surface section 13c2.

Furthermore, column sections 15 extending in the vertical direction are formed in the first housing 11 inside the board insertion recessed sections 13. The column section 15 is a polygonal column shaped member with a substantially rectangular cross section and is formed near the center of the first housing 11 in the width direction with the front side surface (X axis positive direction surface) facing the mating recessed section 12c. Note that in the present Embodiment, the column section 15 positioned in the upper side board insertion recessed section 13A will be described as the upper side column section 15A and the column section 15 positioned in the lower side board insertion recessed section 13B will be described as the lower side column section 15B but when describing the upper side column section 15A and the lower side column section 15B collectively, column sections 15 will be used as the description.

As viewed from a vertical direction (Z axis direction), the upper side column section 15A has a cross sectional shape similar to that illustrated in FIG. 5(a). The dimension in the width direction (Y axis direction) thereof is slightly smaller than the dimension of the mating recessed section 12c in the width direction (Y axis direction) and the front side surface thereof demarcates a large portion of the rear end surface of the mating recessed section 12c corresponding to the upper side board insertion recessed section 13A and is exposed in the mating recessed section 12c. Note that the upper side column section 15A includes a main body section 15a with a substantially rectangular cross section having a large dimension in the width direction and a protruding section 15b with a dimension in the width direction smaller than that of the main body section 15a and a substantially rectangular cross section protruding rearward from the main body section 15a (X axis negative direction). The protruding section 15b is formed with a center in the width direction thereof that deviates to one side from the center in the width direction of the main body section 15a, in other words, to the left side (Y axis positive direction side) such that the left side surface of the protruding section 15b and the left side surface of the main body section 15a constitute the same surface. In addition, the right side surface of the protruding section 15b is positioned to the left of the right side surface of the main body section 15a and a missing section 15c is formed by demarcation with the two surfaces of the right side surface of the protruding section 15b and the rear side surface of the main body section 15a. The missing section 15c has a hook or rectangular cross sectional shape as illustrated in FIG. 5(a).

In addition, the lower side column section 15B has a substantially rectangular cross sectional shape as illustrated in FIG. 5(b) when viewed from a vertical direction (Z axis direction). The dimension thereof in the width direction (Y axis direction) is smaller than the dimension of the mating recessed section 12c in the width direction (Y axis direction) and the center in the width direction deviates to the other side of the center of the mating recessed section 12c in the width direction, in other words, the right side (Y axis negative direction side). Furthermore, the front side surface of the lower side column section 15B demarcates half or more of the rear end surface of the mating recessed section 12c corresponding to the lower side board insertion recessed section 13B and is exposed inside the mating recessed section 12c. Unlike the upper side column section 15A, the lower side column section 15B only includes a main body section 15a having a substantially rectangular cross section and does not include a section corresponding to the protruding section 15b or a section corresponding to the missing section 15c.

FIGS. 8(a) and (b) respectively illustrate plan views of areas that are a prescribed distance from the front end 90f of the upper side FPC 90A and the lower side FPC 90B. Note that FPC 90 is generally a long band-shaped member but illustration of the section that is separated more than the aforementioned prescribed distance from the front end 90f is omitted for convenience of description. Furthermore, a flat plate shaped reinforcing plate 92 is mounted on the terminal contact surface that is the surface of the FPC 90 main body 91 that is in contact with the terminals 161 of the second connector 101, in other words, over an area of prescribed length from the front end 90f on the side opposite the front side surface, the non-terminal contact surface, namely, on the back side surface. This reinforcing plate 92 is composed of, for example, an insulating resin film or the like and is desirably adhered to the back side surface of the main body 91 by adhesive or the like as a reinforcing member. Note that the prescribed length is desirably slightly longer than the length of the first housing 11 from the front end protrusion section 12a2 of the mating main section 12a to the rear surface 11r and that the vicinity of the rear end of the reinforcing plate 92 is visible when the FPC 90 is mounted on the first connector 10.

In addition, a specified area from the front end 90f of the front side surface of the main body 91 has the insulative coating removed and the conductor wires are exposed. Note that the area with the insulative coating removed is desirably smaller than the area to which the reinforcing plate 92 is attached. A plurality of conductor wires (for example, roughly 12) extend in the longitudinal direction (X axis direction) of the FPC 90 and are arranged parallel at a prescribed pitch (for example, roughly 1 to 2 [mm]). Note that the number and pitch of the conductor wires correspond to and are suitably changed according to the number and pitch of the terminals 161 of the second connector 101.

The FPC 90 has a bifurcated tip and a separation section 94 recessed to the rear (X axis negative direction) is formed in the center of the front end 90f in the width direction (Y axis direction). The separation section 94 is a space where the main body 91 and the reinforcing plate 92 are missing and is a space opened at the front end 90f.

Furthermore, the separation section 94 of the upper side FPC 90A has the shape illustrated in FIG. 8(a) as viewed from a vertical direction (Z axis direction) and includes a substantially rectangular main body section 94a with a large dimension in the width direction and a substantially rectangular protruding section 94b with a dimension in the width direction smaller than that of the main body section 94a protruding rearward (X axis negative direction) from the main body section 94a. Note that the center in the width direction of the main body section 94a matches the center in the width direction of the upper side FPC 90A. The protruding section 94b is formed with a center in the width direction thereof that deviates to one side from the center in the width direction of the main body section 94a, in other words, to the left side (Y axis positive direction side) such that the left side surface of the protruding section 94b and the left side surface of the main body section 94a constitute the same surface. In addition, the right side surface of the protruding section 94b is positioned to the left of the right side surface of the main body section 94a and a protruding piece 94c is formed by demarcation with the two surfaces of the right side surface of the protruding section 94b and the rear side surface of the main body section 94a. The protruding piece 94c has a hook or rectangular cross sectional shape as illustrated in FIG. 8(a).

The separation section 94 of the upper side FPC 90A is a portion that engages with the upper side column section 15A and a section towards the rear end (X axis negative direction end) thereof stows the upper side column section 15A. Therefore, the shape of the portion towards the rear end of the separation section 94 has the same cross sectional shape as the upper side column section 15A when viewed in the vertical direction (Z axis direction). The dimensions in the width direction of the main body section 94a, the width direction and front-to-back direction of the protruding section 94b, and the width direction and front-to-back direction of the protruding piece 94c are nearly the same as those of the main body section 15a, the protruding section 15b, and the missing section 15c of the upper side column section 15A cross section. Note that the dimension in the width direction of the main body section 94a is nearly the same as that of the main body section 15a in the upper side column section 15A cross section and so is slightly smaller than that in the width direction of the mating recessed section 12c.

In addition, the separation section 94 of the lower side FPC 90B has the shape illustrated in FIG. 8(b) as viewed from a vertical direction (Z axis direction) and includes a substantially rectangular main body section 94a with a large dimension in the width direction and a substantially rectangular protruding section 94b with a dimension in the width direction smaller than that of the main body section 94a protruding rearward (X axis negative direction) from the main body section 94a. Note that the center in the width direction of the main body section 94a matches the center in the width direction of the lower side FPC 90B. The protruding section 94b is formed with a center in the width direction thereof that deviates to the other side from the center in the width direction of the main body section 94a, in other words, to the right side (Y axis negative direction side) such that the right side surface of the protruding section 94b and the right side surface of the main body section 94a constitute the same surface. In addition, the left side surface of the protruding section 94b is positioned to the right of the left side surface of the main body section 94a and a protruding piece 94c is formed by demarcation with the two surfaces of the left side surface of the protruding section 94b and the rear side surface of the main body section 94a. The protruding piece 94c has a hook or rectangular cross sectional shape as illustrated in FIG. 8(b).

The separation section 94 of the lower side FPC 90B is a portion that engages with the lower side column section 15B and the protruding section 94b is the portion toward the rear end (X axis negative direction end) thereof that stows the lower side column section 15B. Therefore, when viewed from the vertical direction (Z axis direction), the shape of the protruding section 94b is the same as the cross section shape of the lower side column section 15B and the dimensions in the width direction and front-to-back direction of the protruding section 94b are nearly the same as those of the main body section 15a of the lower side column section 15B cross section. Note that the dimension of the width direction of the main body section 94a is slightly smaller than that of the mating recessed section 12c.

Furthermore, the FPC 90 is inserted through the rear surface 11r of the first housing 11 and into the board insertion recessed section 13 for mounting to the first connector 10. Specifically, from an orientation of the front end 90f thereof facing the rear surface 11r of the first housing 11, the FPC 90 is moved forward relative to the first housing 11 and inserted into the board insertion recessed section 13. Here, with an orientation of the front side surface, the surface on which the reinforcing plate 92 is not attached, facing the partition wall 14, the upper side FPC 90A is inserted into the upper side board insertion recessed section 13A and with the orientation of the front side surface, the surface on which the reinforcing plate 92 is not attached, facing the partition wall 14, the lower side FPC 90B is inserted into the lower side board insertion recessed section 13B.

Portions near both ends of the FPC 90 in the width direction are relatively moved forward inside the end part insertion recess section 13b until the front end 90f abuts the engaging protrusions 14b. Here, the inclined surface section 14b1 is formed on the rear end side of the engaging protrusions 14b so the FPC 90 can smoothly ride up onto the engaging protrusions 14b and continue to move forward. Subsequently, the front end 90f comes into contact with the press protrusion sections 13c. Here, inclined surface sections 13c1 are formed on the rear end of the press protrusion sections 13c so the FPC 90 can smoothly ride up on the press protrusion sections 13c and continue to move forward. Furthermore, the front end 90f of the portion of the FPC 90 inserted into the center insertion recessed section 13a slides through the front-to-back communication opening 13a1 and along the surface of the mating main planes 12d, where upon reaching the front end protrusion sections 12a2, attaching of the FPC 90 to the first connector 10 is complete. Therefore, as illustrated in FIG. 11, the front end 90f of the FPC 90 abuts or is in close proximity to the tip end guide 12a3.

When attaching of the FPC 90 to the first connector 10 is complete, the column section 15 of the first housing 11 enters into and engages with the separation section 94 formed in the center in the width direction of the FPC 90. As illustrated in FIG. 11(a), the separation section 94 of the upper side FPC 90A engages with the upper side column section 15A. The main body section 15a of the upper side column section 15A is stowed in and engages with the portion toward the rear end (X axis negative direction) of the main body section 94a of the separation section 94. The protruding section 15b of the upper side column section 15A is stowed in and engages with the protruding section 94b of the separation section 94. The protruding piece 94c of the separation section 94 is stowed in and engages with the missing section 15c of the upper side column section 15A. In addition, as illustrated in FIG. 11(b), the separation section 94 of the lower side FPC 90B engages with the lower side column section 15B and the main body section 15a of the lower side column section 15B is stowed in and engages with the protruding section 94b of the separation section 94.

In the present Embodiment, the shape of the upper side column section 15A in plan view and the shape of the lower side column section 15B in plan view both have at least a portion that deviates to one side or the other in the width direction from the center of the first housing 11 or the mating recessed section 12c in the width direction (Y axis direction) and are mutually different. In addition, the shape of separation section 94 of the upper side FPC 90A that engages with the upper side column section 15A in plan view and the shape of the separation section 94 of the lower side FPC 90B that engages with the lower side column section 15B in plan view both have at least a portion that deviates to one side or the other in the width direction from the center of the FPC 90 (Y axis direction) and are mutually different. For example, as illustrated in FIGS. 8(a), (b), the dimensions in the width direction (Y axis direction) of the main body section 94a are the same but the length in the front-to-back direction of the upper side FPC 90A main body section 94a may be larger than the length of the lower side FPC 90B main body section 94a. In addition, the dimensions of the width direction and front-to-back direction of the upper side FPC 90A protruding section 94b may be smaller than the dimensions of the width direction and front-to-back direction of the lower side FPC 90B protruding section 94b. Furthermore, the protrusion amount of the upper side FPC 90A protruding piece 94c in the width direction may be larger than the protrusion amount of the lower side FPC 90B protruding piece 94c in the width direction. These differences enable identifying whether the FPC 90 is the upper side FPC 90A or the lower side FPC 90B even prior to attaching the FPC 90 to the first connector 10.

Therefore, only the upper side FPC 90A in the correct orientation can be inserted into the upper side board insertion recessed section 13A of the first housing 11, and an incorrect type of FPC 90 such as the lower side FPC 90B cannot be inserted. Here, even when the correct type of FPC is chosen, in other words the upper side FPC 90A, insertion with an incorrect orientation such as an inverted orientation is not feasible. In a similar manner, only the lower side FPC 90B in the correct orientation can be inserted into the lower side board insertion recessed section 13B of the first housing 11 and an incorrect type of FPC 90 such as the upper side FPC 90A cannot be inserted. Here, even if the type is correct, in other words, the lower side FPC 90B, insertion with an incorrect orientation such as an inverted orientation, is not feasible.

In addition, when attaching of the FPC 90 to the first connector 10 is complete, as illustrated in FIG. 9(a), the internal end part of the FPC 90 separation section 94 mates with the recessed communication opening 13a3 that is a slit formed in the mating internal wall section 12e and as illustrated in FIG. 9(b), the engaging protrusions 14b enter into and engage with the engaging openings 93 formed at both ends in the width direction of the FPC 90. In this state, even if an external force is imparted so as to pull the FPC 90 backwards (X axis negative direction), there is an inclined surface section 14b1 extending in the vertical direction (Z axis direction) formed on the front end of the engaging protrusions 14b and the inclined surface section 14b1 hooks on the front end of the engaging openings 93 so engagement of the engaging protrusions 14b in the engaging openings 93 will not be released. Furthermore, a portion of the FPC 90 more forward than and to the outside in the width direction of the engaging openings 93 is pushed toward the partition wall 14 by the press protrusion section 13c so that the releasing of the engagement of the engaging protrusions 14b from the engaging openings 93 is more reliably prevented.

Moreover, the windows 13b1 having a slit shape are formed at positions corresponding to the engaging protrusions 14b in the upper surface (Z axis positive direction surface) and lower surface (Z axis negative direction surface) of the mating side section 12b enabling the operator to visually confirm whether portions near both ends of the FPC 90 in the width direction are inserted into the end part insertion recess sections 13b of the mating side sections 12b and whether the engaging protrusions 14b are engaged in the engaging openings 93 from outside the first connector 10.

Furthermore, when attachment of the FPC 90 to the first connector 10 is complete, as illustrated in FIG. 9(a), the surface of the mating main planes 12d is covered with the FPC 90 enabling visual confirmation of the front end 90f reaching the front end protrusion sections 12a2 that protrude from the mating main planes 12d from outside the first connector 10.

Next, the configuration of the second connector 101 will be described.

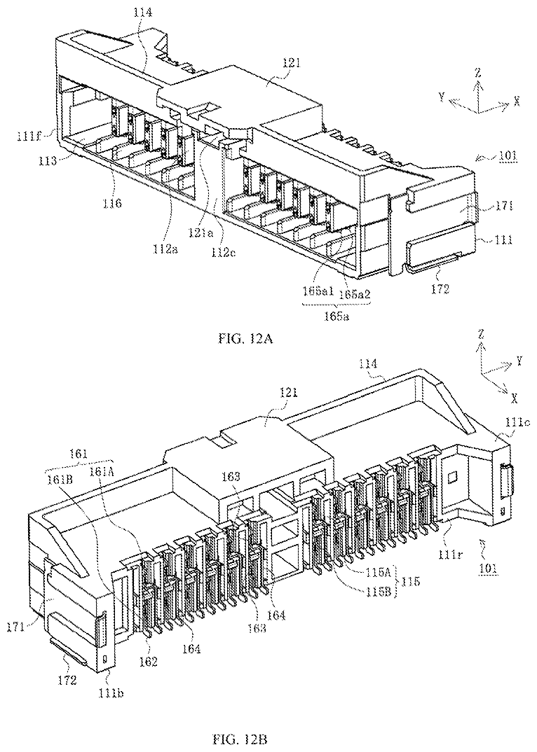

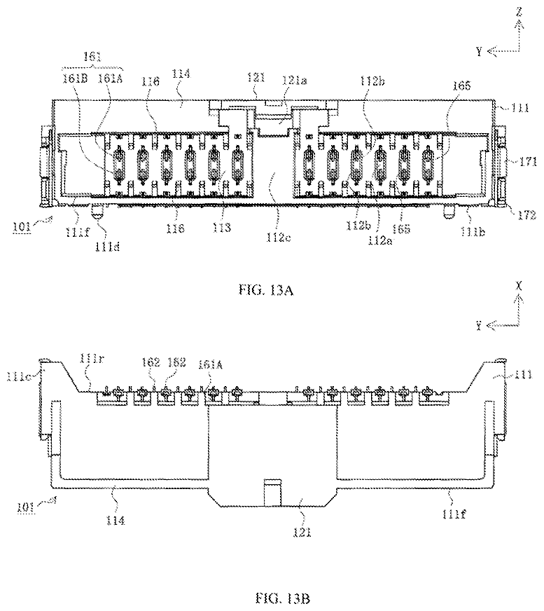

FIG. 12 is a perspective view of the second connector according to Embodiment 1. FIG. 13 is a two-plane view of the second connector according to Embodiment 1. Note that in FIG. 12, (a) is a first perspective view and (b) is a second perspective view. In FIG. 13, (a) is a front view and (b) is a top view.

The second connector 101 according to the present Embodiment includes a second housing 111 as a housing integrally formed using an insulating material such as synthetic resin, and terminals 161 formed through processing such as punching, bending, and the like of a conductive metal plate. The second connector 101 is a board connector mounted as a mounted member on the surface of a board (not shown) and mates with the first connector 10. In the example illustrated in the figure, the second connector 101 is a so-called right angle type. When mating with the first connector 10, the direction of movement relative to the first connector 10 is parallel to the surface of the board and it follows that the front surface 111f that is the mating surface of the second connector 101 second housing 111 is perpendicular to the mounting surface 111b. Note that the second connector 101 does not necessarily have to be a right angle type and may be a so-called straight type where when mating with the first connector 10, the direction of movement relative to the first connector 10 is perpendicular to the board surface and the front surface 111f that is the mating surface of the second housing 111 is parallel to the mounting surface 111b. The second connector 101 may also be a wiring connector for connecting to the tip end of another FPC or electrical wire. The second connector 101 may also be a type called a relay connector for connecting with another connector but for convenience of description, the case of being a right angle type will be described.

As illustrated in the figure, the second housing 111 has a substantially rectangular body external shape elongated in the width direction (Y-axis direction). Furthermore, the second housing 111 includes a mating recessed section 113 that is open at the front surface 111f that is the mating surface for mating with the first connector 10. In addition, the second housing 111 includes side wall sections 111c formed at both ends in the width direction (Y axis direction) and auxiliary fittings 171 that are mounted to the side wall sections 111c for more reliable mounting on the board. The auxiliary fittings 171 are members formed by performing processing such as punching and bending of a metal plate and a tail section 172 is formed on the lower end as a board connecting part that extends outward in the width direction (Y axis direction). The tail section 172 is connected by soldering to a connection pad or the like formed on the surface of the board. Furthermore, the second housing 111 includes a protrusion 111d that protrudes from the mounting surface 111b downward (Z axis negative direction). This protrusion 111d is inserted into and engages with a hole formed on the surface of the board.

In addition, a flange section 114 in the shape of a wall protruding upward (Z axis positive direction) is formed on the front surface 111f of the second housing 111. Furthermore, a member to be locked 121 is formed in the center in the width direction of the upper surface (Z axis positive direction surface) of the second housing 111 as a mated state retaining device for retaining the mated state with the first connector 10. The member to be locked 121 is a member that engages and locks with the lock member 21 of the first connector 10 and includes a lock recessed section 121a that engages with the lock protruding section 21a of the lock member 21.

Furthermore, a mating column section 112c is formed in the center of the mating recessed section 113 in the width direction (Y axis direction) as a column section that mates with the mating recessed section 12c of the first connector 10. The mating column section 112c is a polygonal column shape member extending vertically (Z axis direction) directly under the member to be locked 121 and the front end surface thereof is formed so as to be flush with the front surface 111f. The mating column section 112c prevents deformation or twisting of the mating recessed section 113 in the vertical direction. In addition, when the second connector 101 is a straight type, the front end surface of the mating column section 112c can function as an adherence surface that a jig can adhere to.

Furthermore, in a state where the first connector 10 and the second connector 101 are mated, the mating column section 112c is stowed inside the mating recessed section 12c of the first connector 10 and the mating sections 11b divided into left and right by the mating recessed section 12c are respectively stowed in the mating recessed sections 113 divided into left and right by the mating column section 112c.

In addition, a plurality of terminal support sections 112a extending in the mating recessed sections 113 from the back to the front (X axis negative direction) are arranged lined up in the width direction. The upper and lower surfaces of the terminal support sections 112a have one terminal stowing groove 112b each, formed extending in the front-to-back direction, and a contact part 165 of each terminal 161 is stowed inside a terminal stowing groove 112b. Note that each contact part 165 is a cantilever type member and a contact protrusion 165a that swells toward the outside of the vertical direction of the terminal support sections 112a is formed on the free end thereof. The contact part 165 branches into two from the base or midway through, and a front contact protrusion 165a1 and a rear contact protrusion 165a2 are formed as the contact protrusions 165a, respectively, on the two free ends. The front contact protrusion 165a1 and rear contact protrusion 165a2 are desirably arranged in tandem. With the first connector 10 and the second connector 101 mated, the terminal support sections 112a are members that enter the terminal insertion recessed sections 12a1 of the first connector 10 and the number and pitch thereof are set to correspond to the number and pitch of the terminal insertion recessed sections 12a1.

Furthermore, a plurality of long and narrow ribs 116 extending in the front-to-back direction protrude from the vertical surface inside the mating recessed sections 113. When the first connector 10 and the second connector 101 are mated, the FPC 90, which is inserted into the mating recessed sections 113 on the surface of the mating main planes 12d of the mating main section 12a, slides along the surface of the long and narrow ribs 116 reducing sliding resistance and therefore enabling smooth sliding.

Furthermore, a plurality of terminal stowage recessed sections 115 into which the terminals 161 are stowed are formed in the second housing 111. The terminal stowage recessed sections 115 are recesses that are open as long narrow slits extending in the front-to-back direction (X axis direction) and the vertical direction (Z axis direction) on the rear surface 111r of the second housing 111 and are demarcated into the upper side terminal stowage recessed sections 115A and lower side terminal stowage recessed sections 115B. In other words, the second housing 111 includes two types of terminal stowage recessed sections 115. The upper side terminal stowage recessed sections 115A and lower side terminal stowage recessed sections 115B respectively communicate with the terminal stowing grooves 112b formed on the upper and lower surfaces of the terminal support sections 112a. In addition, a plurality of upper side terminal stowage recessed sections 115A and lower side terminal stowage recessed sections 115B are each arranged lined up in the width direction (Y axis direction) and the number and pitch thereof are set to correspond to the number and pitch of the terminal stowing grooves 112b. Furthermore, of the terminals 161, the upper side terminals 161A are inserted into the upper side terminal stowage recessed sections 115A and the lower side terminals 161B are inserted into the lower side terminal stowage recessed sections 115B.

Note that with the present Embodiment, when the upper side terminal stowage recessed sections 115A and lower side terminal stowage recessed sections 115B are collectively described, they are described as terminal stowage recessed sections 115 and when the upper side terminals 161A and lower side terminals 161B are collectively described, they are described as terminals 161.

Each terminal 161 includes a main body section 163 that is a flat plate member extending in the vertical direction (Z axis direction) and the front-to-back direction (X axis direction) and is stowed and retained in one of the terminal stowage recessed sections 115, a contacting section 164 that extends downward (Z axis negative direction) from the rear end (X axis positive direction end) of the main body section 163, a tail section 162 that protrudes rearward (X axis positive direction) from the lower end (Z axis negative direction end) of the contacting section 164 as the board connecting part, a cantilever shape contact part 165 extending forward (X axis negative direction) from the front end (X axis negative direction end) of the main body section 163, and a contact protrusion 165a formed on the free end of the contact part 165. The tail section 162 is connected by soldering to a connection pad or the like formed on the surface of the board.

Furthermore, the main body sections 163, contact parts 165, and contact protrusions 165a of the upper side terminals 161A and the main body sections 163, contact parts 165, and contact protrusions 165a of the lower side terminals 161B are formed to be mutually symmetric about the plane of symmetry extending in the width direction (Y axis direction) and the front-to-back direction (X axis direction) at the center of the mating recessed sections 113 in the vertical direction (Z axis direction). Therefore, the contact protrusions 165a of the upper side terminals 161A face upwards and protrude upwards from the upper surface of the terminal support sections 112a while the contact protrusions 165a of the lower side terminals 161B face downwards and protrude downwards from the lower surface of the terminal support section 112a.

On the other hand, the contacting sections 164 and tail sections 162 are formed extending in the same direction for both the upper side terminals 161A and the lower side terminals 161B. Furthermore, the contacting sections 164 of the lower side terminals 161B have a relatively small dimension in the vertical direction (Z axis direction) and when viewed in the front-to-back direction, extend in a straight line in the vertical direction while the dimension of the contacting sections 164 of the upper side terminals 161A in the vertical direction is relatively large and when viewed from a front-to-back direction, extends bent in a crank shape in the vertical direction.

Regarding the upper side terminals 161A and lower side terminals 161B positioned directly below the upper side terminals 161A viewed in the front-to-back direction, the main body sections 163 are in the same position in the width direction (Y axis direction), and the tail sections 162 are in different positions in the width direction (Y axis direction). Specifically, when viewed from the front-to-back direction, the main body sections 163 and tail sections 162 of the lower side terminals 161B are positioned in a straight line extending in the vertical direction and the main body sections 163 of the upper side terminals 161A are also positioned in a straight line but the tail sections 162 of the upper side terminals 161A deviate to one side from the tail sections 162 of the lower side terminals 161B in the width direction (in FIG. 12(b), right side: Y axis positive direction side). Note that the tail sections 162 of the upper side terminals 161A are positioned roughly in the center of adjacent tail sections 162 of the upper side terminals 161A [note: source indicates “upper” here]. Therefore, contacting sections 164 that connect the main body sections 163 and the tail sections 162 of the upper side terminals 161A have a bent crank shape so as to not have interference with the contacting sections 164 and tail sections 162 of the lower side terminals 161B. Thus, as illustrated in FIG. 12(b), the tail sections 162 of all of the terminals 161 are arranged in a row in the width direction (Y axis direction).

Next, the operation of mating the first connector 10 and the second connector 101 with the above configuration is described.

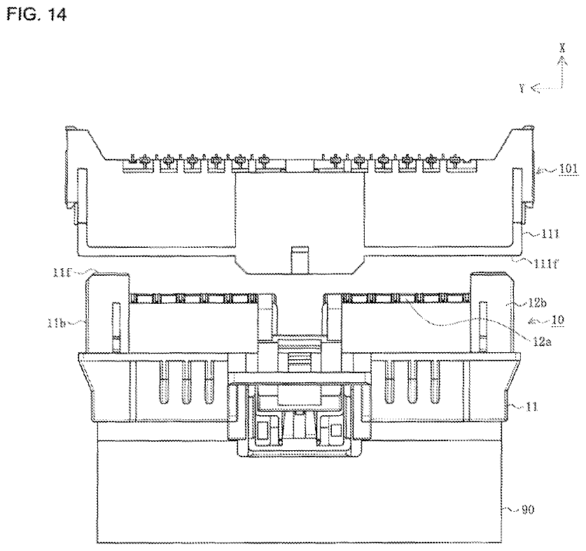

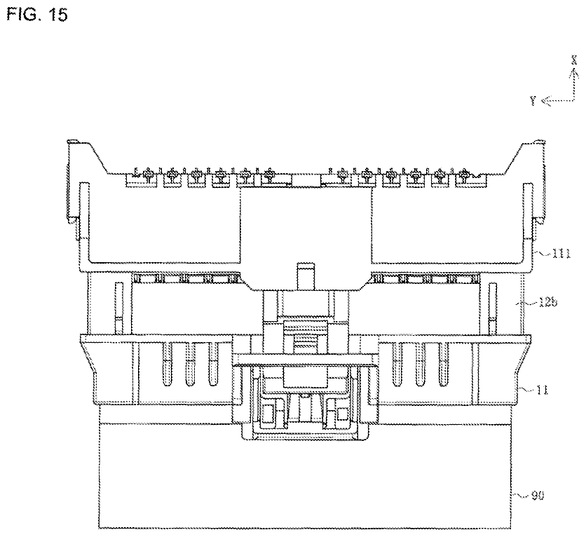

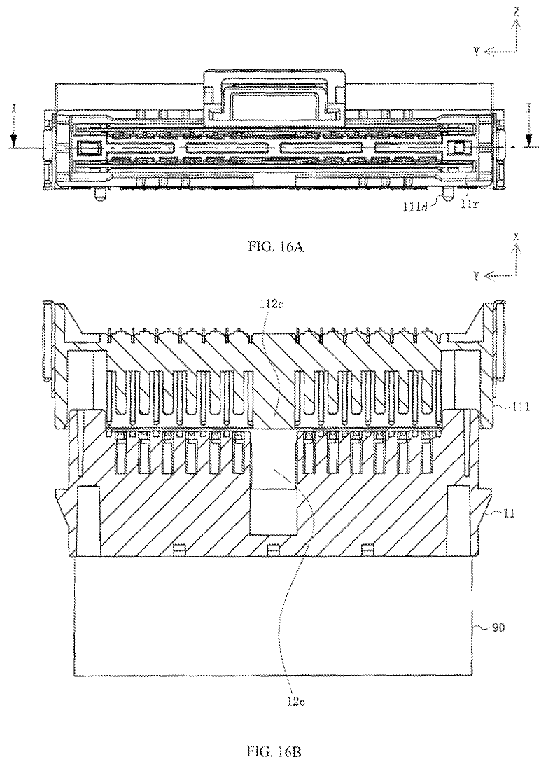

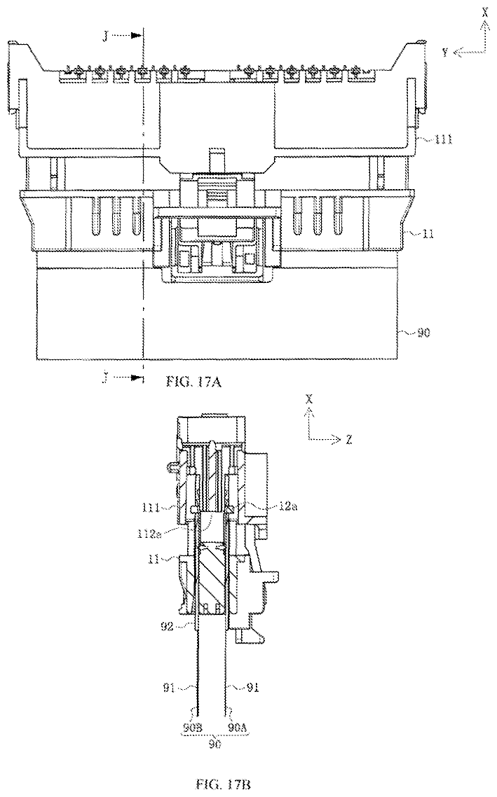

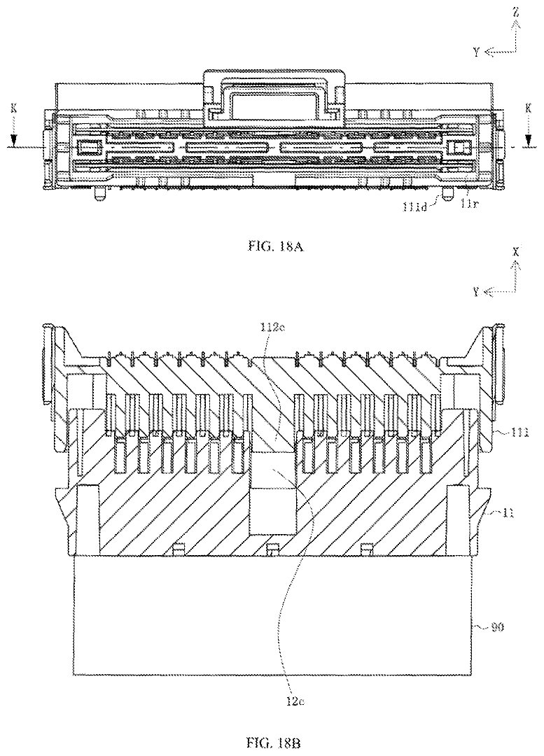

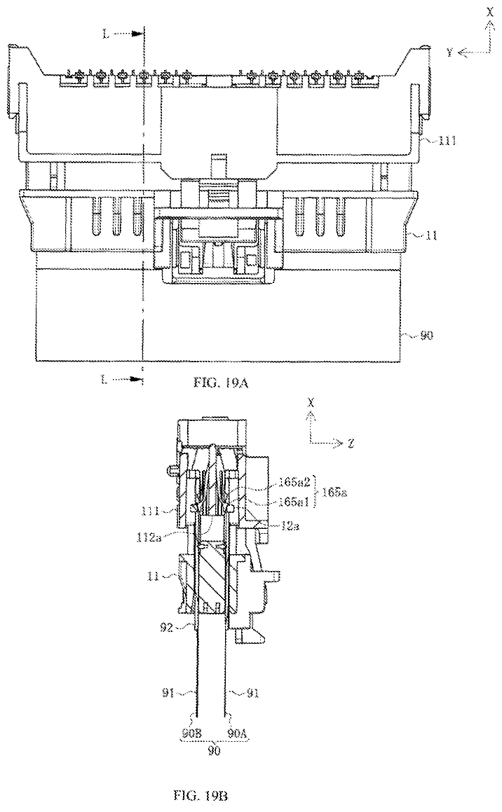

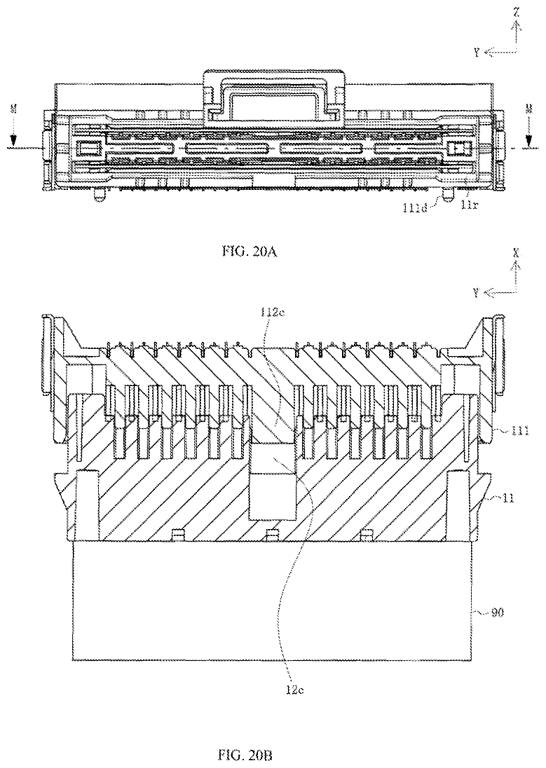

FIG. 14 is a top view illustrating the first connector and the second connector according to Embodiment 1 in a prior to mating state. FIG. 15 is a top view illustrating the first connector and the second connector according to Embodiment 1 in a state of starting to mate. FIG. 16 is a two-plane view illustrating the first connector and the second connector according to Embodiment 1 in a state of starting to mate. FIG. 17 is a first two-plane view illustrating the first connector and the second connector according to Embodiment 1 in a state in the middle of mating. FIG. 18 is a second two-plane view illustrating the first connector and the second connector according to Embodiment 1 in a state in the middle of mating. FIG. 19 is a first two-plane view illustrating the first connector and the second connector according to Embodiment 1 in a state at the end of mating. FIG. 20 is a second two-plane view illustrating the first connector and the second connector according to Embodiment 1 in a state at the end of mating. Note that in FIG. 16, (a) is a view from behind the first connector and (b) is a sectional view taken along the line I-I in (a), in FIG. 17, (a) is a top view and (b) is a sectional view taken along the line J-J in (a), in FIG. 18, (a) is a view from behind the first connector and (b) is a sectional view taken along the line K-K in (a), in FIG. 19, (a) is a top view and (b) is a sectional view taken along the line L-L in (a), and in FIG. 20, (a) is a view from behind the first connector and (b) is a sectional view taken along the line M-M in (a).

Here, it is assumed that the first connector 10 completes attachment of the upper side FPC 90A and lower side FPC 90B. In addition, with the protrusion 111d being inserted into and engaging with a hole formed on the surface of the substrate (not shown) and the tail sections 162 of the terminals 161 and tail sections 172 of the auxiliary fittings 171 being connected to connection pads on the surface of the substrate (not shown) by soldering, the second connector 101 is mounted to the surface of the board. In addition, the connection pads that the tail sections 162 of the terminals 161 are connected to are assumed to connect to conductive traces on the board for transmitting electric current of signals and the like.

First, as illustrated in FIG. 14, the operator sets the front surface 11f that is the mating surface of the first connector 10 first housing 11 facing the front surface 111f that is the mating surface of the second connector 101 and adjusts the position of the mating section 11b of the first connector 10 first housing 11 to match the position of the mating recessed section 113 of the second connector 101 second housing 111. This completes positioning of the first connector 10 and the second connector 101.

In this state, when the first connector 10 and/or second connector 101 are moved in a direction of approaching the counterpart side, in other words, in a mating direction, mating is started, and first, as illustrated in FIGS. 15 and 16, the vicinity of the front end surface of the mating side sections 12b of the first housing 11 enter into the mating recessed sections 113. However, the mating main section 12a has not entered the mating recessed section 113.

Subsequently, when the first connector 10 and/or second connector 101 are moved further in a mating direction, a middle of mating state is entered and as illustrated in FIGS. 17 and 18, the vicinity of the front end surface of the mating main section 12a of the first housing 11 also enters into the mating recessed section 113. Here, the tip end parts of the left and right mating side sections 12b that function as guide protrusions protruding forward have entered into the mating recessed sections 113 to a certain degree of depth so the orientation of the first connector 10 relative to the second connector 101 stabilizes and the first connector 10 and/or second connector 101 can be moved in the mating direction.

Subsequently, as the first connector 10 and/or the second connector 101 are further moved in the mating direction, a state at the end of mating is entered and as illustrated in FIGS. 19 and 20, a half or more of the left and right mating side sections 12b have entered into the mating recessed sections 113. In addition, the vicinity of the front end surface of the mating column section 112c of the second housing 111 enters into the mating recessed section 12c of the first housing 11 and the vicinity of the front end surface of the terminal support sections 112a of the second housing 111 enter into the terminal insertion recessed sections 12a1 of the mating main section 12a of the first housing 11.

Therefore, the contact protrusions 165a formed on the free ends of the contact parts 165 of the terminals 161 move relatively toward the rear (X axis negative direction) of the first housing 11 and come into contact with the surface of the conductor wires exposed on the surface side of the FPC 90; however, first, contact is made with the surface of the tip end guide 12a3 and then the front end 90f comes into contact with the surface of the conductor wires of the FPC 90 that abuts or is close to the tip end guide 12a3. Here, as described above, the protrusion height of the tip end guide 12a3 is set lower than the surface of the FPC 90 conductor wires so after the contact protrusions 165a contact the surface of the tip end guide 12a3 and are elastically deformed, they contact the surface of the FPC 90 conductor wires and are further elastically deformed. In other words, when the contact protrusions 165a of the cantilever type contact parts 165 come into contact with the surface of the tip end guide 12a3, they are elastically deformed, and thereafter the contact protrusions 165a come into contact with the surface of the FPC 90 conductor wires and are further elastically deformed. In this manner, the contact parts 165 are caused to deform prior to the contact protrusions 165a coming into contact with the FPC 90 enabling reducing damage to the FPC 90. In addition, the scraping of the tip end guide 12a3 caused by the sliding contact of the contact protrusion 165a on the surface of the tip end guide 12a3 can be reduced.

Thereafter, further moving in the mating direction of the first connector 10 and/or second connector 101 completes the mating and the mating column section 112c in the second housing 111 enters into and mates with the mating recessed section 12c in the first housing 11. In addition, the terminal support sections 112a in the second housing 111 enter into the terminal insertion recessed sections 12a1 of the mating main section 12a in the first housing 11 and the contact protrusions 165a of the upper side terminals 161A protruding upward from the upper surface of the terminal support sections 112a come into contact with the conductor wires of the upper side FPC 90A, enabling conduction, and the contact protrusions 165a of the lower side terminals 161B that protrude downward from the lower surface of the terminal support sections 112a come into contact with the conductor wires of the lower side FPC 90B, enabling conduction. Thus, the first connector 10 and second connector 101 can be reliably mated without damage to the various parts of the first connector 10 and/or the second connector 101 or the terminals 161, and the conductor wires of the upper side FPC 90A are able to conduct with the corresponding upper side terminals 161A and the conductor wires of the lower side FPC 90B are able to conduct with the corresponding lower side terminals 161B.

In this manner, in the present Embodiment, the first connector 10 includes a first housing 11 that a FPC 90 with a bifurcated tip end can be mounted to. Furthermore, the first housing 11 includes: a column section 15 that engages with the separation section 94 formed in the center of the FPC 90 in the width direction and engaging protrusions 14b that enter into and engage with engaging openings 93 formed at both ends of the FPC 90 in the width direction; the engaging protrusions 14b are formed protruding from the side of the FPC 90 opposite the reinforcing plate 92 toward the reinforcing plate 92 side; and the first housing 11 further includes the mating recessed section 12c formed in the center thereof in the width direction, and the recessed communication opening 13a3 formed in the mating recessed section 12c into which the internal end part of the FPC 90 separation section 94 is fitted.

Thus, despite being small and having a low profile, reliability of the first connector 10 will be improved and will exhibit high strength, and will enable simple, reliable, and precise mounting in a short period of time such that even a FPC 90 with a bifurcated tip will not be damaged and front and back will not be incorrect.

In addition, at least a portion of the column section 15 deviates to one side or the other in the width direction from the center of the mating recessed section 12c in the width direction. Therefore, by forming the separation section 94 of the FPC 90 in accordance with the shape of the column section 15, the FPC 90 can only be inserted when the orientation of the FPC 90 is correct, enabling preventing incorrect insertion of the FPC 90.

Furthermore, a window 13b1 enabling viewing the engagement state of the engaging openings 93 and the engaging protrusions 14b is formed on the outer wall surface of the first housing 11. Thereby, the state of the FPC 90 being inserted to a proper position can be visually confirmed from outside the first connector 10.

Furthermore, the first housing 11 includes press protrusion sections 13c formed to the outside of the engaging protrusions 14b in the width direction, that protrude in the direction opposite the engaging protrusions 14b, and that are able to contact a portion of the surface on the reinforcing plate 92 side of the FPC 90 closer to the front end 90f than the engaging openings 93. Thus, the vicinity of the FPC 90 front end 90f deforms, preventing release of the engagement of the engaging openings 93 and the engaging protrusions 14b and pulling out of the FPC 90. In addition, flapping of the vicinity of the FPC 90 front end 90f can be prevented.

Furthermore, the first housing 11 includes releasing spaces 13d formed closer to the front surface 11f than the engaging protrusions 14b. Thus, when disengaging the FPC 90 mounted to the first connector 10, a releasing tool (not shown) can be inserted into the releasing spaces 13d enabling the release operation of the engagement of the engaging protrusions 14b in the engaging openings 93.

Next, Embodiment 2 will be described below. Note that, for portions having the same structure as that of Embodiment 1, descriptions thereof are omitted by giving the same reference numerals thereto. Moreover, descriptions of the same operations and effects as those of Embodiment 1 will be omitted.

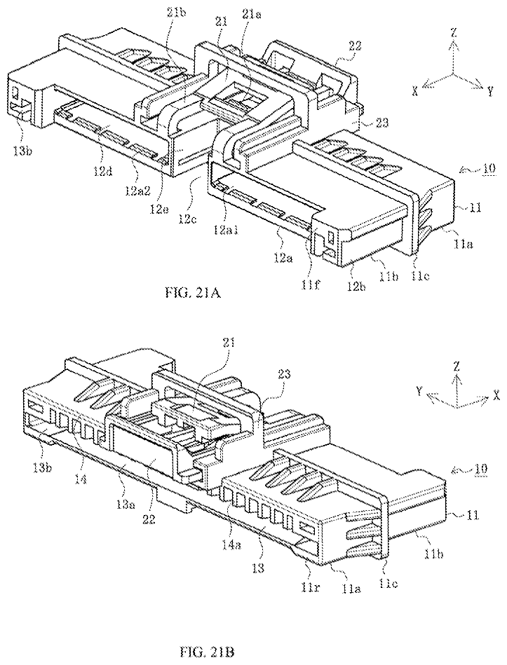

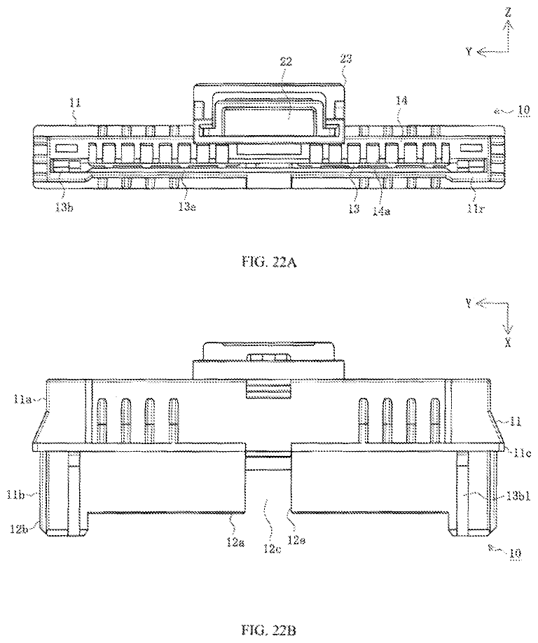

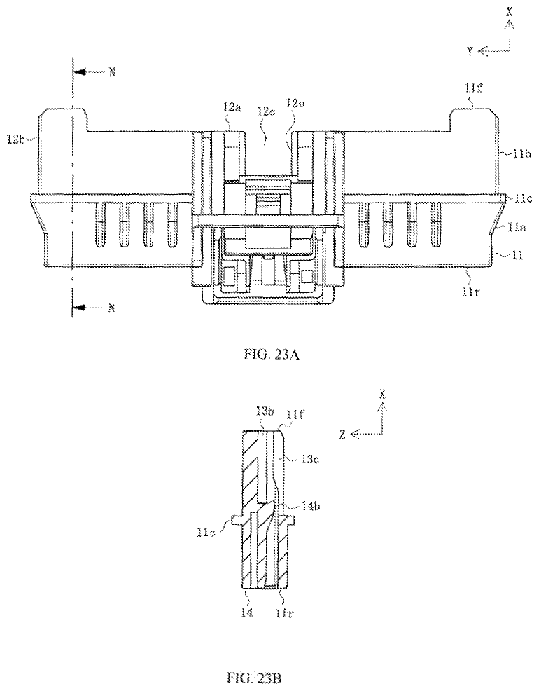

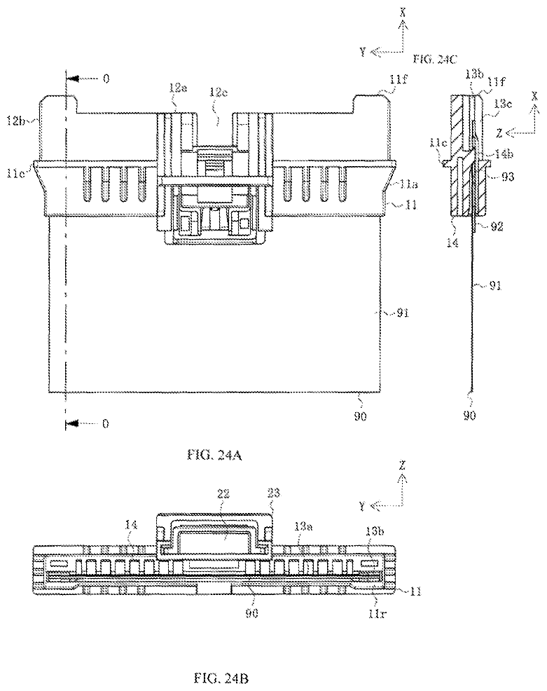

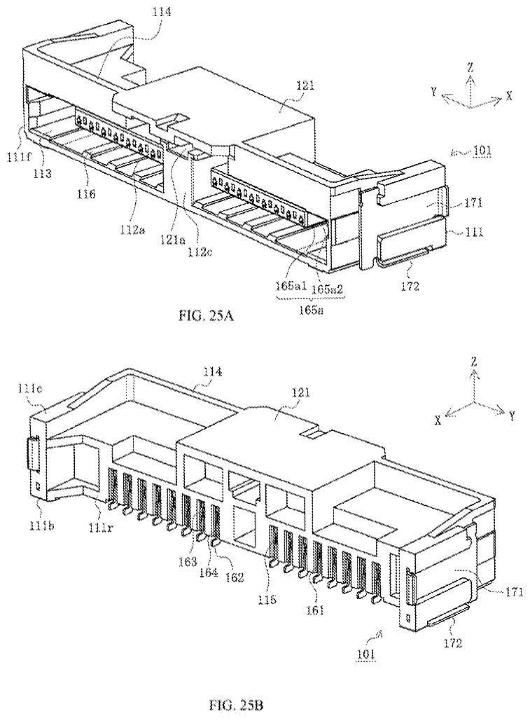

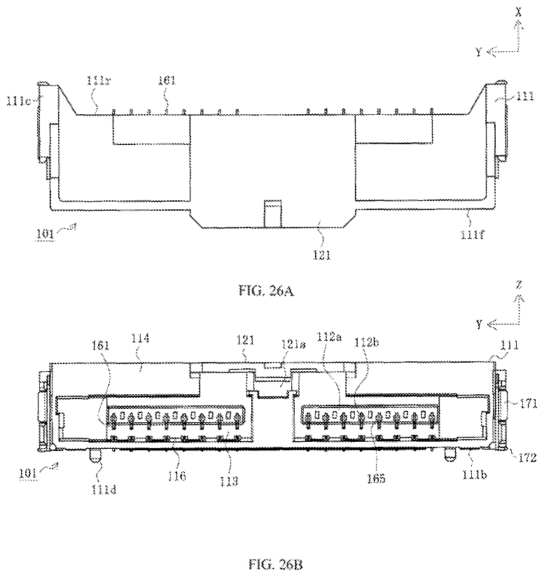

FIG. 21 is a perspective view of the first connector according to Embodiment 2. FIG. 22 is a first two-plane view of the first connector according to Embodiment 2. FIG. 23 is a second two-plane view of the first connector according to Embodiment 2. FIG. 24 is a three-plane diagram of the first connector mounted on a FPC according to Embodiment 2. FIG. 25 is a perspective view of the second connector according to Embodiment 2. FIG. 26 is a two-plane view of the second connector according to Embodiment 2. In FIG. 21, (a) is a view seen obliquely from the front and (b) is a view seen obliquely from behind. In FIG. 22, (a) is a rear view, and (b) is a bottom view. In FIG. 23, (a) is a top view and (b) is a sectional view taken along the line N-N in (a). In FIG. 24, (a) is a top view, (b) is a rear view and (c) is a sectional view taken along the line O-O in (a). In FIG. 25, (a) is a view seen obliquely from the front and (b) is a view seen obliquely from behind. In FIG. 26, (a) is top view and (b) is a front view.

In Embodiment 1, the first housing 11 of the first connector 10 includes two board insertion recessed sections 13, in other words, the upper side board insertion recessed section 13A and the lower side board insertion recessed section 13B, whereas in the present Embodiment, as illustrated in FIGS. 21(b) and 22(a), the first housing 11 of the first connector 10 only includes one board insertion recessed section 13. Therefore, only one FPC 90 is provided in the present Embodiment.

In the example illustrated in the figures, the first housing 11 of the first connector 10 according to the present Embodiment only includes the board insertion recessed section 13 corresponding to the lower side board insertion recessed section 13B in Embodiment 1 and does not include the board insertion recessed section 13 corresponding to the upper side board insertion recessed section 13A in Embodiment 1. Therefore, there is no board insertion recessed section 13 above the partition wall 14 and the board insertion recessed section 13 is only present below the partition wall 14. The upper surface portion of the first housing 11 main body section 11a is constituted by the partition wall 14 and a rib 14a protrudes from the lower surface of the partition wall 14 inside the center insertion recessed section 13a. Furthermore, the FPC 90 is inserted into the board insertion recessed section 13 with an orientation of the surface on which the reinforcing plate 92 is not attached facing the partition wall 14.

In addition, with regards to Embodiment 1, which has a plurality of terminal insertion recessed sections 12a1 being formed lined up in the width direction within each demarcated area of the mating main section 12a divided into two in the width direction (Y axis direction) by the mating recessed section 12c, in the present Embodiment, as illustrated in FIG. 21(a), only one terminal insertion recessed section 12a1 extending in the width direction is formed within each demarcated area of the mating main section 12a divided into two in the width direction (Y axis direction) by the mating recessed section 12c. Furthermore, in the present Embodiment, the mating main plane 12d is set as the lower inner surface of the terminal insertion recessed section 12a1 and the front end protrusion section 12a2 that defines the front end of the mating main plane 12d protrudes from the lower inner surface of the terminal insertion recessed section 12a1.

In Embodiment 1, there are two types of terminal stowage recessed sections 115 included in the second housing 111 of the second connector 101, in other words, the upper side terminal stowage recessed sections 115A and the lower side terminal stowage recessed sections 115B are included, while in the present Embodiment, as illustrated in FIG. 25(b), there is only one type of terminal stowage recessed section 115 included in the second housing 111 of the second connector 101. Therefore, there is only one type of terminal 161 included in the present Embodiment and only a terminal similar to the lower side terminal 161B of Embodiment 1 is included.

In addition, with regards to Embodiment 1, which has a plurality of terminal support sections 112a being formed lined up in each demarcated area of the mating recessed sections 113 divided into two in the width direction (Y axis direction) by the mating column section 112c, in the present Embodiment, as illustrated in FIG. 25(a) and FIG. 26(b), only one terminal support section 112a is formed extending in the width direction within each demarcated area of the mating recessed section 113 divided into two in the width direction (Y axis direction) by the mating column section 112c. Furthermore, a plurality of terminal stowing grooves 112b that extend in the front-to-back direction are formed lined up in the width direction on the lower surface of each terminal support section 112a, and the contact parts 165 of each terminal 161 are stowed in each of the terminal stowing grooves 112b. The contact protrusions 165a formed on the free end of the contact parts 165 face downward and protrude downward from the lower surface of the terminal support sections 112a

Note that the basic configuration of the first connector 10 and the second connector 101 in the present Embodiment is the same as that of Embodiment 1 described above; therefore, a description thereof is omitted.

In addition, the basic operation of attaching the FPC 90 to the first connector 10 in the present Embodiment is the same as that of Embodiment 1; therefore, a description thereof is omitted.

Furthermore, an operation of mating the first connector 10 and the second connector 101 in the present Embodiment and basic configurations and effects of the state of being mated and other points of the first connector 10 and the second connector 101 are also the same as those of Embodiment 1 described above; therefore, descriptions thereof are omitted.

Note that the disclosure herein describes features relating to suitable exemplary Embodiments. Various other Embodiments, modifications, and variations within the scope and spirit of the claims appended hereto will naturally be conceived of by those skilled in the art upon review of the disclosure herein.

The present disclosure can be applied to a FPC connector and a connector pair.

1. An FPC connector comprising:
(a) a housing enabling attaching of a FPC with a bifurcated tip, wherein
(b) the housing includes: a column section that engages a separation section formed in the center of the FPC in the width direction, and engagement protrusions that enter into and engage with engaging openings formed at both ends of the FPC in the width direction;
(c) the engagement protrusions are formed protruding from the side of the FPC opposite the reinforcement plate toward the reinforcement plate side; and
(d) the housing further includes a recessed section formed in the center thereof in the width direction and a slit formed in the recessed section that an internal end part of the FPC separation section fits into.

2. The FPC connector according to claim 1, wherein at least a portion of the column section deviates to one side or the other of the center of the recessed section in the width direction.

3. The FPC connector according to claim 1, wherein a viewing window enabling viewing the engagement state of the engaging opening and the engagement protrusion is formed in the outer wall surface of the housing.

4. The FPC connector according to claim 1, wherein the housing includes a press protrusion section formed to the outside of the engagement protrusion in the width direction that protrudes in the opposite direction as that of the engagement protrusion and contacts a portion on the reinforcement plate side surface of the FPC that is closer to the front than the engaging opening.

5. The FPC connector according to claim 1, wherein the housing includes a releasing space formed closer to the front than the engagement protrusion.

6. A connector pair, comprising:
the FPC connector according to claim 1 and a counterpart connector that mates with the FPC connector.
